(19) United States
(12) Patent Application Publication
(10) Pub. No.: US 2013/0002628 A1
(43) Pub. Date: Jan. 3, 2013

(54) METHOD FOR DRIVING PLASMA DISPLAY DEVICE, PLASMA DISPLAY DEVICE, AND PLASMA DISPLAY SYSTEM

(76) Inventors: Yuichi Sakai, Osaka (JP); Hidehiko Shoji, Osaka (JP); Naoyuki Tomioka, Osaka (JP); Yuya Shiozaki, Osaka (JP)

(21) Appl. No.: 13/583,899

(22) PCT Filed: Feb. 25, 2011
(86) PCT No.: PCT/JP2011/001093

§ 371 Date: Sep. 10, 2012

(30) Foreign Application Priority Data
Mar. 9, 2010 (JP) 2010-051380

(51) Int. Cl. G06F 3/038

(52) U.S. Cl. 345/208

(57) ABSTRACT

In a plasma display apparatus displaying a stereoscopic image, crosstalk is reduced and an address discharge is caused stably. For this purpose, in the plasma display apparatus displaying a stereoscopic image, each field has a plurality of subfields, each having a sustain period where an up-ramp waveform voltage is applied to the scan electrodes after all the sustain pulses are generated. The luminance weights of the respective subfields are set such that the subfield having the lightest luminance weight is generated first in each field, the subfield having the heaviest luminance weight is generated second, and the third subfield and those thereafter have luminance weights sequentially decreasing. The up-ramp waveform voltage in the sustain period of the first subfield in each field is generated so as to have a gradient gentler than that of the up-ramp waveform voltage in the sustain periods of the subfields generated second and thereafter.

### TECHNICAL FIELD

The present invention relates to a plasma display apparatus driving method, a plasma display apparatus, and a plasma display system that alternately display, on the plasma display panel, an image for the right eye and an image for the left eye that can be stereoscopically viewed using a pair of shutter glasses.

### BACKGROUND ART

In an AC surface discharge panel, i.e. a typical plasma display panel (hereinafter, simply referred to as “panel”), a large number of discharge cells are formed between a front substrate and a rear substrate facing each other. With the front substrate, a plurality of display electrode pairs, each including a scan electrode and a sustain electrode, is formed in parallel with each other on the front glass substrate. A dielectric layer and a protective layer are formed so as to cover these display electrode pairs.

With the rear substrate, a plurality of parallel data electrodes is formed on the rear glass substrate. A dielectric layer is formed so as to cover these data electrodes. On the dielectric layer, a plurality of barrier ribs is formed in parallel with the data electrodes. Phosphor layers are formed on the surface of the dielectric layer and on the side faces of the barrier ribs.

The front substrate and the rear substrate are opposed to each other and sealed together such that the display electrode pairs three-dimensionally intersect the data electrodes. In the sealed inside discharge space, a discharge gas containing xenon at a partial pressure ratio of 5%, for example, is sealed, and discharge cells are formed in the parts where the display electrode pairs face the data electrodes. In the thus structured panel, a gas discharge generates ultraviolet rays in each discharge cell, and the ultraviolet rays excite the phosphors of red (R) color, green (G) color, and blue (B) color such that the phosphors of the respective colors emit light for color image display.

A typically used method for driving the panel is a subfield method. In the subfield method, gradations are displayed by dividing one field into a plurality of subfields and causing light emission or no light emission in each discharge cell in each subfield. Each of the subfields has an initializing period, an address period, and a sustain period.

In the initializing periods, initializing waveforms are applied to the respective scan electrodes so as to cause an initializing discharge in the respective discharge cells. This operation forms wall charge necessary for the subsequent address operation in the respective discharge cells, and generates priming particles (excitation particles for generating a discharge) for generating an address discharge stably.

The initializing operation includes the following two types: a forced initializing operation for causing an initializing discharge in the discharge cells regardless of the operation in the immediately preceding subfield; and a selective initializing operation for causing an initializing discharge only in the discharge cells having undergone an address discharge in the immediately preceding subfield.

In the address periods, a scan pulse is sequentially applied to the scan electrodes, and an address pulse is applied selectively to the data electrodes based on the signals of the image to be displayed. This operation causes an address discharge between the scan electrodes and the data electrodes in the discharge cells to be lit and forms wall charge in the discharge cells (hereinafter, these operations being also generically referred to as “addressing”).

In the sustain periods, a number of sustain pulses based on the luminance weight predetermined for each subfield are applied alternately to the display electrode pairs, each including a scan electrode and a sustain electrode. This operation causes a sustain discharge in the discharge cells having undergone the address discharge, and causes the phosphor layers of the discharge cells to emit light. (Hereinafter, causing a discharge cell to be lit by a sustain discharge is also referred to as “lighting”, and causing a discharge cell not to be lit as “non-lighting”.) Thus, the respective discharge cells are lit at luminances corresponding to the luminance weight. In this manner, the respective discharge cells of the panel are lit at luminances corresponding to the gradation values of the image signals for image display in the image display area of the panel. The light emission of the phosphor layers caused by this sustain discharge is a light emission related to gradation display. The light emission caused by the forced initializing operation is a light emission unrelated to gradation display.

As one of the subfield methods, the following driving method is disclosed. In this driving method, a forced initializing operation is performed using a gently-changing ramp waveform voltage and an initializing operation is further performed selectively in the discharge cells having undergone a sustain discharge. In this driving method, a forced initializing operation is performed once in a field. This operation can enhance the contrast by minimizing the light emission unrelated to gradation display and reducing the luminance in display of black, i.e. the lowest gradation (see Patent Literature 1, for example.)

Further, methods for displaying an image for stereoscopic view (hereinafter, “stereoscopic image”) using such a panel and for using a plasma display apparatus as a stereoscopic image display apparatus are considered. In this plasma display apparatus, an image for the right eye and an image for the left eye that form a stereoscopic view are alternately displayed on the panel, and the user views the image using special glasses called a pair of shutter glasses (see Patent Literature 2, for example).

The pair of shutter glasses includes a shutter for the right eye and a shutter for the left eye. In the period during which an image for the right eye is displayed on the panel, the right eye shutter is opened (in a state of transmitting visible light) and the left eye shutter is closed (in a state of blocking visible light). In the period during which an image for the left eye is displayed, the left eye shutter is opened and the right eye shutter is closed. This operation enables the user to view the image for the right eye only with the right eye, and the image for the left eye only with the left eye. Thus, the user can stereoscopically view the stereoscopic image displayed on the panel.

However, the phosphors used in the panel have a long afterglow time. There is a phosphor material that has a characteristic of persistence of afterglow for several milliseconds after the completion of a sustain discharge. The afterglow is a phenomenon such that the light emission continues even after the completion of the discharge in a discharge cell. The afterglow time is a time taken until the afterglow sufficiently decreases.

Therefore, for example, even after the period for display of an image for the right eye has been completed, the image for the right eye is displayed on the panel as an afterimage for a short while in some cases. The afterimage is a phenomenon such that an image is displayed on the panel by the afterglow even after the completion of the display period of the image.

When an image for the left eye is displayed on the panel before the afterimage of an image for the right eye disappears, the phenomenon of entry of the image for the right eye into the image for the left eye occurs. Similarly, when an image for the right eye is displayed on the panel before the afterimage of an image for the left eye disappears, the phenomenon of entry of the image for the left eye into the image for the right eye occurs. Hereinafter, such a phenomenon is referred to as “crosstalk”. Occurrence of crosstalk makes stereoscopic view difficult.

In the driving method in which the forced initializing operation is performed once in one field, the amount of wall charge and the amount of priming particles necessary for causing a stable address discharge depend largely on the arrangement of subfields in comparison with the driving method in which a plurality of forced initializing operations is performed in one field. The arrangement of subfields means a subfield structure, e.g. which is a subfield where a forced initializing operation is performed, and how luminance weights are allocated to the respective subfields.

Insufficient priming particles, reduced wall charge, or the like can destabilize the address discharge and degrade the image display quality in the plasma display apparatus.

### CITATION LIST

### Patent Literature

PTL1
Japanese Patent Unexamined Publication No. 2000-242224
PTL2
Japanese Patent Unexamined Publication No. 2000-112428

### SUMMARY OF THE INVENTION

In a plasma display apparatus driving method of the present invention,

the plasma display apparatus displaying an image by alternately repeating a field for the right eye for display of an image signal for the right eye and a field for the left eye for display of an image signal for the left eye, using a panel,

the panel having a plurality of discharge cells arranged therein, each of the discharge cells having a scan electrode, a sustain electrode, and a data electrode,

the driving method includes:

setting each of the field for the right eye and the field for the left eye such that each of the fields has a plurality of subfields, each of the subfields has an initializing period, an address period, and a sustain period where an up-ramp waveform voltage is applied to the scan electrodes after sustain pulses corresponding in number to a luminance weight are generated;

in each of the field for the right eye and the field for the left eye, setting the luminance weights of the respective subfields such that the subfield generated first is the subfield having the lightest luminance weight, the subfield generated second is the subfield having the heaviest luminance weight, and the subfields generated third and thereafter have luminance weights sequentially decreasing; and

generating the up-ramp waveform voltage to be applied to the scan electrodes in the sustain period of the subfield generated first in each of the field for the right eye and the field for the left eye such that the up-ramp waveform voltage has a gradient gentler than that of the up-ramp waveform voltage to be applied to the scan electrodes in the sustain periods of the subfields generated second and thereafter.

This method can enhance the image display quality by reducing crosstalk to the user who views a stereoscopic image displayed on the panel through a pair of shutter glasses and generating an address discharge stably in a plasma display apparatus usable as a stereoscopic image display apparatus.

A plasma display apparatus of the present invention includes the following elements:

a panel having a plurality of discharge cells arranged therein, each of the discharge cells having a scan electrode, a sustain electrode, and a data electrode; and

a driver circuit for driving the panel,

the plasma display apparatus displaying an image on the panel by alternately repeating a field for the right eye for display of an image signal for the right eye and a field for the left eye for display of an image signal for the left eye.

The driver circuit drives the panel in a manner such that: each of the field for the right eye and the field for the left eye has a plurality of subfields, each of the subfields has an initializing period, an address period, and a sustain period where an up-ramp waveform voltage is applied to the scan electrodes after sustain pulses corresponding in number to a luminance weight are generated; in each of the field for the right eye and the field for the left eye, the luminance weights of the respective subfields are set such that the subfield generated first is the subfield having the lightest luminance weight, the subfield generated second is the subfield having the heaviest luminance weight, and the subfields generated third and thereafter have luminance weights sequentially decreasing; and the up-ramp waveform voltage to be applied to the scan electrodes in the sustain period of the first subfield in each of the field for the right eye and the field for the left eye is generated so as to have a gradient gentler than that of the up-ramp waveform voltage to be applied to the scan electrodes in the sustain periods of the subfields generated second and thereafter.

This configuration can enhance the image display quality by reducing crosstalk to the user who views a stereoscopic image displayed on the panel through a pair of shutter glasses and generating an address discharge stably in a plasma display apparatus usable as a stereoscopic image display apparatus.

In the plasma display apparatus of the present invention, the driver circuit may include a control signal output part for outputting a shutter control signal in synchronization with the field for the right eye and the field for the left eye.

A plasma display system of the present invention includes the following elements:

a plasma display apparatus including the following elements:
a panel having a plurality of discharge cells arranged therein, each of the discharge cells having a scan electrode, a sustain electrode, and a data electrode; and
a driver circuit for driving the panel, the driver circuit including a control signal output part for outputting a shutter control signal in synchronization with a field for the right eye and a field for the left eye,

the plasma display apparatus displaying an image on the panel by alternately repeating a field for the right eye for display of an image signal for the right eye and a field for the left eye for display of an image signal for the left eye; and

a pair of shutter glasses including a control signal receiver for receiving the shutter control signal, a right eye shutter, and a left eye shutter, the right eye shutter and the left eye shutter opening and closing in response to the shutter control signal.

The driver circuit drives the panel in a manner such that: each of the field for the right eye and the field for the left eye has a plurality of subfields, each of the subfields has an initializing period, an address period, and a sustain period where an up-ramp waveform voltage is applied to the scan electrodes after sustain pulses corresponding in number to a luminance weight are generated; in each of the field for the right eye and the field for the left eye, the luminance weights of the respective subfields are set such that the subfield generated first is the subfield having the lightest luminance weight, the subfield generated second is the subfield having the heaviest luminance weight, and the subfields generated third and thereafter have luminance weights sequentially decreasing; and the up-ramp waveform voltage to be applied to the scan electrodes in the sustain period of the first subfield in each of the field for the right eye and the field for the left eye is generated so as to have a gradient gentler than that of the up-ramp waveform voltage to be applied to the scan electrodes in the sustain periods of the subfields generated second and thereafter.

This configuration can enhance the image display quality by reducing crosstalk to the user who views a stereoscopic image displayed on the panel through the pair of shutter glasses and generating an address discharge stably in a plasma display apparatus usable as a stereoscopic image display apparatus.

### BRIEF DESCRIPTION OF DRAWINGS

FIG. 1 is an exploded perspective view showing a structure of a panel for use in a plasma display apparatus in accordance with a first exemplary embodiment of the present invention.

FIG. 2 is an electrode array diagram of the panel for use in the plasma display apparatus in accordance with the first exemplary embodiment.

FIG. 3 shows a circuit block diagram of the plasma display apparatus and a diagram schematically showing a plasma display system in accordance with the first exemplary embodiment.

FIG. 4 is a chart schematically showing driving voltage waveforms applied to respective electrodes of the panel for use in the plasma display apparatus in accordance with the first exemplary embodiment.

FIG. 5 is a diagram schematically showing a subfield structure in the plasma display apparatus, and opening/closing operations of a pair of shutter glasses in accordance with the first exemplary embodiment.

FIG. 6 is a circuit diagram showing a configuration example of a scan electrode driver circuit of the plasma display apparatus in accordance with the first exemplary embodiment.

FIG. 7 is a chart schematically showing driving voltage waveforms applied to the respective electrodes of the panel for use in the plasma display apparatus in accordance with a second exemplary embodiment of the present invention.

### DESCRIPTION OF EMBODIMENTS

Hereinafter, a plasma display apparatus and a plasma display system in accordance with exemplary embodiments of the present invention are described with reference to the accompanying drawings.

### First Exemplary Embodiment

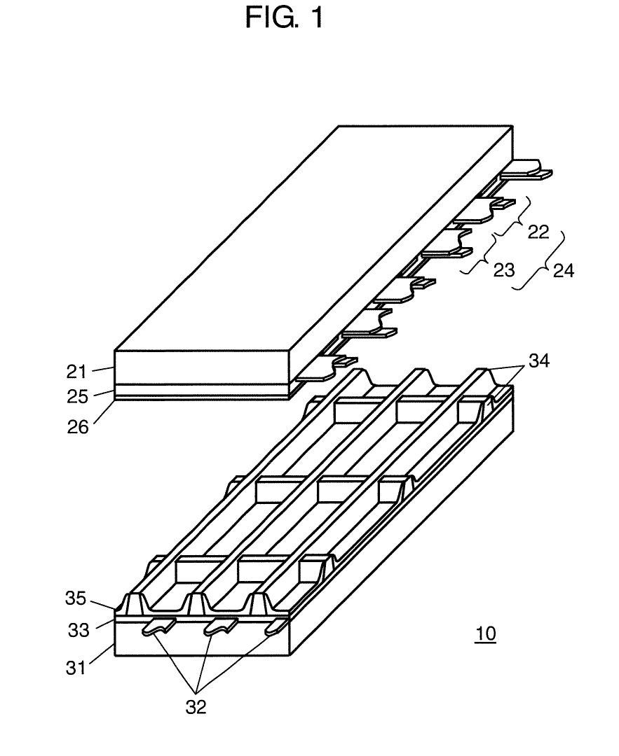

FIG. 1 is an exploded perspective view showing a structure of panel 10 for use in a plasma display apparatus in accordance with the first exemplary embodiment of the present invention. A plurality of display electrode pairs 24, each including scan electrode 22 and sustain electrode 23, is disposed on glass front substrate 21. Dielectric layer 25 is formed so as to cover scan electrodes 22 and sustain electrodes 23. Protective layer 26 is formed over dielectric layer 25.

In order to lower a discharge start voltage in the discharge cells, protective layer 26 is formed of a material predominantly composed of magnesium oxide (MgO). MgO has proven performance as a panel material, and has a large secondary electron emission coefficient and excellent durability when neon (Ne)-xenon (Xe) gas is sealed.

A plurality of data electrodes 32 is formed on glass rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red (R) color, green (G) color, and blue (B) color are formed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a neon-xenon mixture gas, for example, is sealed as a discharge gas.

The discharge space is partitioned into a plurality of compartments by barrier ribs 34. Discharge cells are formed in the intersecting parts of display electrode pairs 24 and data electrodes 32. In this manner, a plurality of discharge cells is formed in panel 10.

These discharge cells cause discharge and the discharge causes phosphor layers 35 of the discharge cells to emit light (lights the discharge cells), so that a color image is displayed on panel 10.

In panel 10, three consecutive discharge cells arranged in the extending direction of display electrode pair 24, i.e. a discharge cell for emitting light of red (R) color, a discharge cell for emitting light of green (G) color, and a discharge cell for emitting light of blue (B) color, form one pixel.

The structure of panel 10 is not limited to the above, and may include barrier ribs in a stripe pattern, for example.

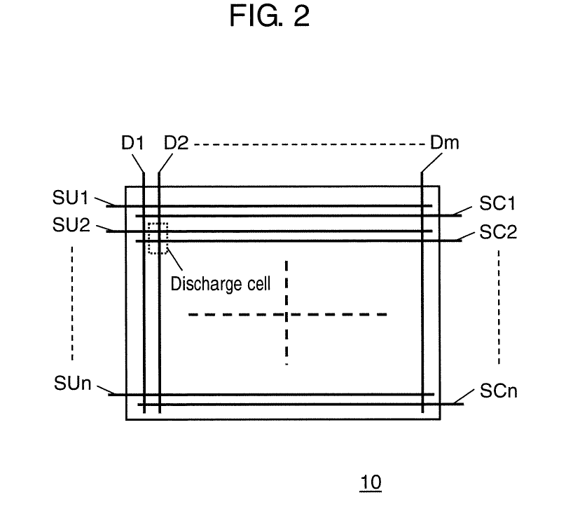

FIG. 2 is an electrode array diagram of panel 10 for use in the plasma display apparatus in accordance with the first exemplary embodiment of the present invention. Panel 10 has n scan electrode SC1-scan electrode SCn (scan electrodes 22 in FIG. 1) and n sustain electrode SU1-sustain electrode SUn (sustain electrodes 23 in FIG. 1) both extending in the horizontal direction (line direction), and m data electrode D1-data electrode Dm (data electrodes 32 in FIG. 1) extending in the vertical (column) direction. A discharge cell is formed in the part where a pair of scan electrode SCi (i=1-n) and sustain electrode SUi intersects one data electrode Dj (j=1-m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920×3 and n=1080.

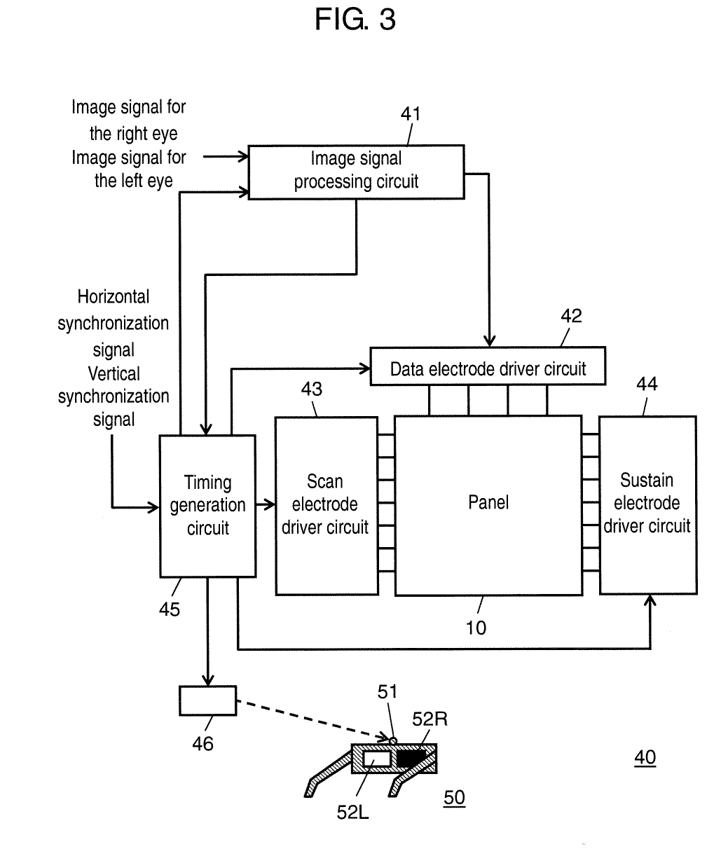

FIG. 3 shows a circuit block diagram of plasma display apparatus 40 and a diagram schematically showing a plasma display system in accordance with the first exemplary embodiment of the present invention. The plasma display system of this exemplary embodiment includes plasma display apparatus 40 and pair of shutter glasses 50 as the elements.

Plasma display apparatus 40 includes the following elements:
panel 10 having a plurality of discharge cells arranged therein, each of the discharge cells having scan electrode 22, sustain electrode 23, and data electrode 32; and
a driver circuit for driving panel 10.
   The driver circuit includes image signal processing circuit 41; data electrode driver circuit 42; scan electrode driver circuit 43; sustain electrode driver circuit 44; timing generation circuit 45; and electric power supply circuits (not shown) for supplying electric power necessary for each circuit block. Plasma display apparatus 40 also has control signal output part 46. Control signal output part 46 supplies a shutter control signal for controlling the opening/closing of the shutters of pair of shutter glasses 50 to be used by the user, to pair of shutter glasses 50.

Image signal processing circuit 41 allocates a gradation value to each discharge cell, based on the input image signal. The image signal processing circuit converts the gradation value into image data representing light emission and no light emission (data where light emission and no light emission correspond to digital signals “1” and “0”, respectively) in each subfield. That is, image signal processing circuit 41 converts the image signals in each field into image data representing light emission and no light emission in each subfield.

When the input image signal includes an R signal, a G signal, and a B signal, the image signal processing circuit allocates the R, G, and B gradation values to the respective discharge cells, based on the R signal, the G signal, and the B signal. When the input image signal includes a luminance signal (Y signal) and a chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield.

When the input image signal is an image signal for stereoscopic view that includes an image signal for the right eye and an image signal for the left eye and the image signal is displayed on panel 10, the image signal for the right eye and the image signal for the left eye are input into image signal processing circuit 41 alternately in each field. Thus, image signal processing circuit 41 converts the image signal for the right eye into image data for the right eye, and the image signal for the left eye into image data for the left eye.

Based on a horizontal synchronization signal and vertical synchronization signal, timing generation circuit 45 generates various timing signals for controlling the operation of each circuit block. Then, the timing generation circuit supplies the generated timing signals to each circuit block (data electrode driver circuit 42, scan electrode driver circuit 43, sustain electrode driver circuit 44, image signal processing circuit 41, or the like).

Timing generation circuit 45 outputs a shutter control signal for controlling the opening/closing of the shutters of pair of shutter glasses 50, to control signal output part 46. Timing generation circuit 45 sets the shutter control signal to ON (“1”) when the shutter of pair of shutter glasses 50 is opened (in a state of transmitting visible light). The timing generation circuit sets the shutter control signal to OFF (“0”) when the shutter of pair of shutter glasses 50 is closed (in a state of blocking visible light). The shutter control signal has the following two types: a control signal (a control signal for the right eye shutter) that is set to ON when a field for the right eye for display of an image signal for the right eye is displayed on panel 10, and is set to OFF when a field for the left eye for display of an image signal for the left eye is displayed on panel 10; and a control signal (a control signal for the left eye shutter) that is set to ON when a field for the left eye for display of an image signal for the left eye is displayed on panel 10, and is set to OFF when a field for the right eye for display of an image signal for the right eye is displayed on panel 10.

Scan electrode driver circuit 43 has an initializing waveform generation circuit, a sustain pulse generation circuit, and a scan pulse generation circuit (not shown in FIG. 3). The scan electrode driver circuit generates driving voltage waveforms, based on the timing signals supplied from timing generation circuit 45, and applies the waveforms to each of scan electrode SC1-scan electrode SCn. Based on the timing signal, the initializing waveform generation circuit generates an initializing waveform to be applied to scan electrode SC1-scan electrode SCn in the initializing periods. Based on the timing signal, the sustain pulse generation circuit generates a sustain pulse to be applied to scan electrode SC1-scan electrode SCn in the sustain periods. The scan pulse generation circuit has a plurality of scan electrode driver ICs (scan ICs). Based on the timing signal, the scan pulse generation circuit generates a scan pulse to be applied to scan electrode SC1-scan electrode SCn in the address periods.

Sustain electrode driver circuit 44 has a sustain pulse generation circuit and a circuit for generating voltage Ve (not shown in FIG. 3), generates a driving voltage waveform based on the timing signal supplied from timing generation circuit 45, and applies the driving voltage waveform to each of sustain electrode SU1-sustain electrode SUn. In the sustain periods, based on the timing signal, sustain pulses are generated and applied to sustain electrode SU1-sustain electrode SUn.

Data electrode driver circuit 42 converts data in each subfield into a signal corresponding to each of data electrode D1-data electrode Dm. The above data forms image data including image data for the right eye and image data for the left eye. Then, based on the above signal, and the timing signal supplied from timing generation circuit 45, the data electrode driver circuit drives each of data electrode D1-data electrode Dm. In the address periods, the data electrode driver circuit generates an address pulse and applies the address pulse to each of data electrode D1-data electrode Dm.

Control signal output part 46 includes a light-emitting element, such as a light-emitting diode (LED). The control signal output part supplies shutter control signals in synchronization with the fields for the right eye and the fields for the left eye, to pair of shutter glasses 50, as those converted into infrared signals, for example.

Pair of shutter glasses 50 has control signal receiver 51 for receiving the shutter control signal output from control signal output part 46, right eye liquid crystal shutter 52R, and left eye liquid crystal shutter 52L. Right eye liquid crystal shutter 52R and left eye liquid crystal shutter 52L can open and close independently. In pair of shutter glasses 50, right eye liquid crystal shutter 52R and left eye liquid crystal shutter 52L open and close in response to the shutter control signals supplied from control signal output part 46. Right eye liquid crystal shutter 52R opens (transmits visible light) when the control signal for the right eye shutter is set to ON, and closes (blocks visible light) when that control signal is set to OFF. Left eye liquid crystal shutter 52L opens (transmits visible light) when the control signal for the left eye shutter is set to ON, and closes (blocks visible light) when that control signal is set to OFF. Right eye liquid crystal shutter 52R and left eye liquid crystal shutter 52L are formed of liquid crystal. However, in the present invention, the material making up the shutters is not limited to liquid crystal. As long as blocking and transmission of visible light can be switched at a high speed, any material may be used.

Next, driving voltage waveforms for driving panel 10 and the operation thereof are described. Plasma display apparatus 40 of this exemplary embodiment displays gradations by a subfield method. In the subfield method, one field is divided into a plurality of subfields along a temporal axis, and a luminance weight is set for each subfield. Each of the subfields has an initializing period, an address period, and a sustain period. An image is displayed on panel 10 by controlling the light emission and no light emission in each discharge cell in each subfield.

The luminance weight represents a ratio of the magnitudes of luminance displayed in each subfield. In the sustain period of each subfield, sustain pulses corresponding in number to the luminance weight are generated. Thus, for example, the luminance of the light emission in the subfield having the luminance weight “8” is approximately eight times as high as that in the subfield having the luminance weight “1”, and is approximately four times as high as that in the subfield having the luminance weight “2”. Thus, various gradations and an image can be displayed by selectively causing light emission in each subfield in combination in response to image signals.

In this exemplary embodiment, the image signal input into plasma display apparatus 40 is an image signal for stereoscopic view where an image signal for the right eye and an image signal for the left eye are repeated alternately in each field. An image for stereoscopic view (an stereoscopic image) made of an image for the right eye and an image for the left eye is displayed on panel 10 by alternately repeating a field for the right eye for display of an image signal for the right eye and a field for the left eye for display of an image signal for the left eye.

Thus, the number of stereoscopic images displayed per unit time (e.g. one second) is a half the field frequency (the number of fields generated per second). For instance, when the field frequency is 60 Hz, 30 images for the right eye and 30 images for the left eye are displayed per second. Thus, 30 stereoscopic images are displayed per second. Then, in this exemplary embodiment, the field frequency is set to twice (e.g. 120 Hz) the general field frequency, and flickering (flickers) likely to occur in display of images having a low field frequency is reduced.

The user views a stereoscopic image displayed on panel 10 through pair of shutter glasses 50 where right eye liquid crystal shutter 52R and left eye liquid crystal shutter 52L open and close independently in synchronization with the field for the right eye and the field for the left eye, respectively. With this operation, the user can view an image for the right eye only with the right eye and an image for the left eye only with the left eye, thereby stereoscopically viewing the stereoscopic image displayed on panel 10.

In the field for the right eye and the field for the left eye, only the signals of the images to be displayed are different. The structure of the field, e.g. the number of subfields forming one field, the luminance weights of the respective subfields, and the arrangement of the subfields, is identical with each other. Hereinafter, when a field “for the right eye” and a field “for the left eye” do not need to be discriminated, each of the field for the right eye and the field for the left eye is simply referred to as a field. Each of an image signal for the right eye and an image signal for the left eye is also simply referred to as an image signal. The structure of the field is also referred to as a subfield structure.

First, a description is provided for the structure of one field, and the driving voltage waveforms to be applied to the respective electrodes. Each of the field for the right eye and the field for the left eye has a plurality of subfields. Each of the subfields includes the following periods: an initializing period during which a down-ramp waveform voltage is applied to scan electrodes 22; an address period during which a scan pulse is applied to scan electrodes 22 and an address pulse is applied selectively to data electrodes 32; and a sustain period during which sustain pulses corresponding in number to the luminance weight are applied to scan electrodes 22 and sustain electrodes 32, and thereafter an up-ramp waveform voltage is applied to scan electrodes 22.

In the initializing periods, an initializing operation is performed so as to cause an initializing discharge in the discharge cells and form wall charge necessary for the address discharge in the subsequent address period on the respective electrodes. The initializing operation includes the following two types: a forced initializing operation for forcedly causing an initializing discharge in the discharge cells regardless of whether a discharge has occurred; and a selective initializing operation for causing an initializing discharge only in the discharge cells having undergone an address discharge in the address period of the immediately preceding subfield.

In the address periods, a scan pulse is applied to scan electrodes 22 and an address pulse is applied selectively to data electrodes 32 so as to cause an address discharge selectively in the discharge cells to be lit and form wall charge for causing a sustain discharge in the subsequent sustain period in the discharge cells.

In the sustain periods, sustain pulses corresponding in number to the luminance weight of each subfield multiplied by a predetermined proportionality factor are applied alternately to scan electrodes 22 and sustain electrodes 23. This proportionality factor is a luminance magnification. For example, when the luminance magnification is 2, in the sustain period of a subfield having the luminance weight “2”, four sustain pulses are applied to each of scan electrodes 22 and sustain electrodes 23. Thus, the number of sustain pulses generated in the sustain period is 8. Then, a sustain discharge is caused for light emission in the discharge cells having undergone an address discharge in the immediately preceding address period. At the end of the sustain period, i.e. after all the sustain pulses have been generated, a gently rising ramp waveform voltage is applied to scan electrodes 22 so as to reduce the wall voltage on scan electrodes 22 and sustain electrodes 23 in the discharge cells having undergone an address discharge.

In this exemplary embodiment, a description is provided for an example where one field is formed of five subfields (subfield SF1, subfield SF2, . . . subfield SF5). A forced initializing operation is performed in the initializing period of subfield SF1, which is generated first in the field, and a selective initializing operation is performed in the initializing periods of subfield SF2-subfield SF5. With this structure, the light emission unrelated to image display is only a light emission caused by the discharge in the forced initializing operation in subfield SF1. Therefore, the luminance of black level, i.e. the luminance of black display area where no sustain discharge occurs, is caused only by the weak light emission in the forced initializing operation. Thus, an image of high contrast can be displayed on panel 10.

The subfields have respective luminance weights of 1, 16, 8, 4, and 2. That is, in this exemplary embodiment, luminance weights are set for the respective subfields in the following manner. Subfield SF1 generated first in a field is set as a subfield having the lightest luminance weight, subfield SF2 generated second is set as a subfield having the heaviest luminance weight, subfields generated third and thereafter have luminance weights sequentially decreasing, and subfield SF5 generated last in the field is set as a subfield having the second lightest luminance weight. The reason for such setting of luminance weights is described later.

However, in this exemplary embodiment, the number of subfields forming one field, and the luminance weights of the respective subfields are not limited to the above values. The subfield structure may be switched based on an image signal, for example.

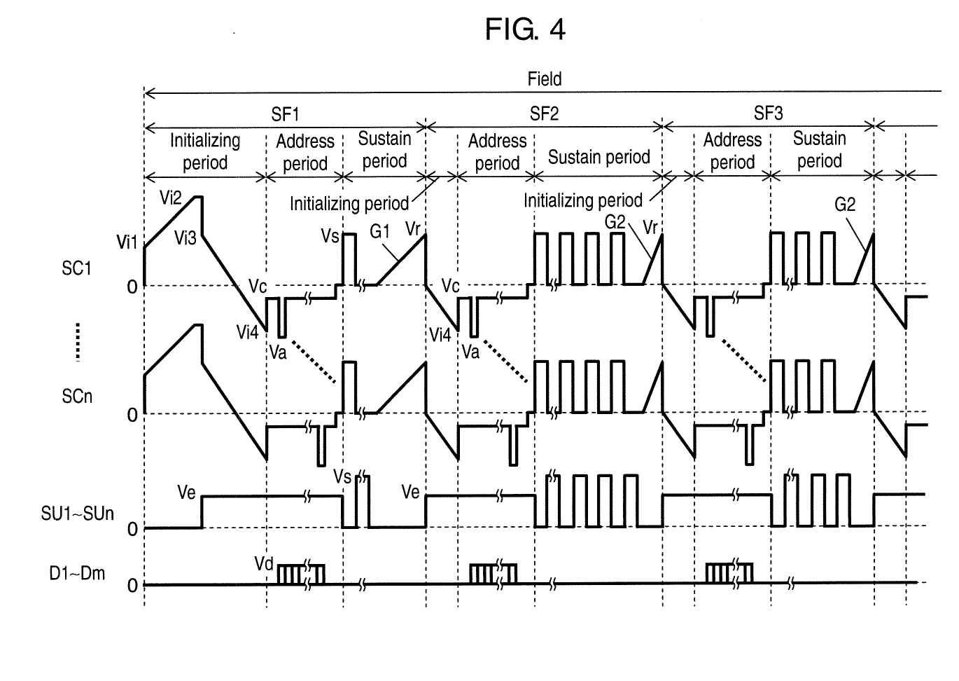

FIG. 4 is a chart showing driving voltage waveforms applied to respective electrodes of panel 10 for use in the plasma display apparatus in accordance with the first exemplary embodiment of the present invention. FIG. 4 shows driving voltage waveforms applied to the following electrodes: scan electrode SC1 for undergoing an address operation first in the address periods; scan electrode SCn for undergoing an address operation last in the address periods; sustain electrode SU1-sustain electrode SUn; and data electrode D1-data electrode Dm.

FIG. 4 shows driving voltage waveforms in subfield SF1 through subfield SF3. Subfield SF1 is a subfield where a forced initializing operation is performed. Subfield SF2 and subfield SF3 are subfields where a selective initializing operation is performed. Therefore, between subfield SF1, and subfield SF2 and subfield SF3, the waveform shapes of the driving voltage applied to scan electrodes 22 in the initializing periods are different.

The driving voltage waveforms in the other subfields are substantially similar to those in subfield SF2 and subfield SF3 except for the numbers of sustain pulses in the sustain periods. Scan electrode SCi, sustain electrode SUi, and data electrode Dk in the following description are the electrodes selected from the respective electrodes, based on image data (data representing light emission and no light emission in each subfield).

First, subfield SF1 is described.

In the first half of the initializing period of subfield SF1, voltage 0 (V) is applied to each of data electrode D1-data electrode Dm and sustain electrode SU1-sustain electrode SUn. Voltage Vi1 and next a ramp waveform voltage gently rising from voltage Vi1 toward voltage Vi2 are applied to scan electrode SC1-scan electrode SCn. Voltage Vi1 is set to a voltage lower than the discharge start voltage with respect to sustain electrode SU1-sustain electrode SUn. Voltage Vi2 is set to a voltage exceeding the discharge start voltage with respect to sustain electrode SU1-sustain electrode SUn.

While this ramp waveform voltage is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm. Then, negative wall voltage accumulates on scan electrode SC1-scan electrode SCn, and positive wall voltage accumulates on data electrode D1-data electrode Dm and sustain electrode SU1-sustain electrode SUn. This wall voltage on the electrodes means voltages that are generated by the wall charge accumulated on the dielectric layers covering the electrodes, the protective layer, the phosphor layers, or the like.

In the second half of the initializing period of subfield SF1, positive voltage Ve is applied to sustain electrode SU1-sustain electrode SUn and voltage 0 (V) is applied to data electrode D1-data electrode Dm. A ramp waveform voltage gently falling from voltage Vi3 toward negative voltage Vi4 is applied to scan electrode SC1-scan electrode SCn. Voltage Vi3 is set to a voltage lower than the discharge start voltage, and voltage Vi4 is set to a voltage exceeding the discharge start voltage with respect to sustain electrode SU1-sustain electrode SUn.

While this ramp waveform voltage is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrode D1-data electrode Dm. This weak discharge reduces the negative wall voltage on scan electrode SC1-scan electrode SCn and the positive wall voltage on sustain electrode SU1-sustain electrode SUn, and adjusts the positive wall voltage on data electrode D1-data electrode Dm to a value suitable for the address operation.

In this manner, the initializing operation in the initializing period of subfield SF1, i.e. the forced initializing operation for forcedly causing an initializing discharge in all the discharge cells, is completed.

In the subsequent address period of subfield SF1, voltage Ve is applied to each of sustain electrode SU1-sustain electrode SUn, and voltage Vc is applied to each of scan electrode SC1-scan electrode SCn.

Next, a negative scan pulse at negative voltage Va is applied to scan electrode SC1 in the first line, which undergoes the address operation first. Further, an address pulse at positive voltage Vd is applied to data electrode Dk of a discharge cell to be lit in the first line among data electrode D1-data electrode Dm.

The voltage difference in the intersecting part of data electrode Dk and scan electrode SC1 in the discharge cell applied with the address pulse at voltage Vd is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve-voltage Va). At this time, setting voltage Ve to a voltage value slightly lower than the discharge start voltage can make the state where a discharge is likely to occur but does not actually occurs between sustain electrode SU1 and scan electrode SC1.

With this setting, a discharge caused between data electrode Dk and scan electrode SC1 can trigger a discharge between the areas of sustain electrode SU1 and scan electrode SC1 intersecting data electrode Dk. Thus, an address discharge occurs in the discharge cell to be lit. Positive wall voltage accumulates on scan electrode SC1, and negative wall voltage accumulates on sustain electrode SU1. Negative wall voltage also accumulates on data electrode Dk.

In this manner, an address operation is performed so as to cause an address discharge in the discharge cells to be lit in the first line and accumulate wall voltage on the respective electrodes. In contrast, the voltage in the intersecting parts of scan electrode SC1 and data electrodes 32 applied with no address pulse does not exceed the discharge start voltage, and thus no address discharge occurs.

The above address operation is sequentially performed on scan electrode SC2, scan electrode SC3 . . . scan electrode SCn in this order until the operation reaches the discharge cells in the n-th line. Thus, the address period of subfield SF1 is completed. In this manner, in the address period, an address discharge is caused selectively in the discharge cells to be lit so as to form wall charge in the discharge cells.

In the subsequent sustain period of subfield SF1, first, voltage 0 (V) is applied to sustain electrode SU1-sustain electrode SUn, and a sustain pulse at positive voltage Vs is applied to scan electrode SC1-scan electrode SCn. In a discharge cell having undergone an address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage, and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and thus the wall voltage at the completion of the initializing period is maintained.

Subsequently, voltage 0 (V) is applied to scan electrode SC1-scan electrode SCn, and a sustain pulse at voltage Vs is applied to sustain electrode SU1-sustain electrode SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses corresponding in number to the luminance weight multiplied by a predetermined luminance magnification are applied alternately to scan electrode SC1-scan electrode SCn and sustain electrode SU1-sustain electrode SUn. By giving an electric potential difference between the electrodes of each display electrode pair 24 in this manner, the sustain discharge is continued in the discharge cells having undergone the address discharge in the address period.

After the sustain pulses have been generated in the sustain period (at the end of the sustain period), a ramp waveform voltage that gently rises with first gradient G1 from voltage 0 (V) as a base electric potential toward voltage Vr is applied to scan electrode SC1-scan electrode SCn while voltage 0 (V) is applied to sustain electrode SU1-sustain electrode SUn and data electrode D1-data electrode Dm.

While the ramp waveform voltage applied to scan electrode SC1-scan electrode SCn is rising higher than the discharge start voltage, a weak discharge continuously occurs in the discharge cells having undergone a sustain discharge. The charged particles generated by this weak discharge accumulate on sustain electrode SUi and scan electrode SCi as wall charge so as to reduce the voltage difference between sustain electrode SUi and scan electrode SCi. This reduces the wall voltage on scan electrode SCi and the wall voltage on sustain electrode SUi while the positive wall voltage on data electrode Dk is left.

After the voltage applied to scan electrode SC1-scan electrode SCn has reached voltage Vr, the voltage applied to scan electrode SC1-scan electrode SCn is lowered to voltage 0 (V). Thus, the sustain operation in the sustain period of subfield SF1 is completed.

In this manner, the driving operation in subfield SF1 is completed.

In the initializing period of subfield SF2, a selective initializing operation is performed so as to apply, to the respective electrodes, driving voltage waveforms where the first half of the initializing period of subfield SF1 is omitted. In the initializing period of subfield SF2, voltage Ve is applied to sustain electrode SU1-sustain electrode SUn and voltage 0 (V) is applied to data electrode D1-data electrode Dm. A ramp waveform voltage gently falling from a voltage (e.g. voltage 0 (V)) lower than the discharge start voltage toward negative voltage Vi4 exceeding the discharge start voltage is applied to scan electrode SC1-scan electrode SCn.

This application causes a weak initializing discharge in the discharge cells having undergone a sustain discharge in the sustain period of the immediately preceding subfield (subfield SF1 in FIG. 4). This initializing discharge reduces the wall voltage on scan electrode SCi and sustain electrode SUi. Since sufficient positive wall voltage is accumulated on data electrode Dk by the sustain discharge caused in the immediately preceding sustain period, the excess part of this wall voltage is discharged and the wall voltage on data electrode Dk is adjusted to a value suitable for the address operation.

In contrast, in the discharge cells having undergone no sustain discharge in the sustain period of the immediately preceding subfield (subfield SF1 in FIG. 4), no initializing discharge occurs, and the wall charge at the completion of the initializing period of the immediately preceding subfield is maintained.

In this manner, the initializing operation in subfield SF2 is a selective initializing operation for causing an initializing discharge selectively in the discharge cells having undergone an address operation in the address period of the immediately preceding subfield, i.e. in the discharge cells having undergone a sustain discharge in the sustain period of the immediately preceding subfield.

In the address period of subfield SF2, an address operation is performed so as to apply the driving voltage waveform similar to that in the address period of subfield SF1 to the respective electrodes and accumulate the wall voltage on the respective electrodes of the discharge cells to be lit.

In the sustain period of subfield SF2, similarly to the sustain period of subfield SF1, sustain pulses corresponding in number to the luminance weight are applied alternately to scan electrode SC1-scan electrode SCn and sustain electrode SU1-sustain electrode SUn so as to cause a sustain discharge in the discharge cells having undergone an address discharge in the address period.

After generation of sustain pulses in the sustain period (at the end of the sustain period) of subfield SF2, a ramp waveform voltage that rises with second gradient G2, which is steeper than first gradient G1, from voltage 0 (V) as the base electric potential toward voltage Vr, is applied to scan electrode SC1-scan electrode SCn while voltage 0 (V) is applied to sustain electrode SU1-sustain electrode SUn and data electrode D1-data electrode Dm. In this manner, similarly to the sustain period of subfield SF1, the wall voltage on scan electrode SCi and sustain electrode SUi is reduced while the positive wall voltage is left on data electrode Dk.

Thus, the sustain operation in the sustain period of subfield SF2 is completed. In this exemplary embodiment, second gradient G2 is set steeper than first gradient G1. This setting can make the time from voltage 0 (V) to voltage Vr shorter than that of the sustain period of subfield SF1 by (Vr/G1)−(Vr/G2) in the sustain period of subfield SF2.

In the initializing periods and address periods of subfield SF3-subfield SF5, driving voltage waveforms similar to those in the initializing period and address period of subfield SF2 are applied to the respective electrodes.

In the sustain periods of subfield SF3-subfield SF5, driving voltage waveforms similar to those in the sustain period of subfield SF2 except for the number of sustain pulses are applied to the respective electrodes. That is, sustain pulses corresponding in number to the luminance weights are applied alternately to scan electrode SC1-scan electrode SCn and sustain electrode SU1-sustain electrode SUn so as to cause a sustain discharge in the discharge cells having undergone an address discharge in the address period. After generation of sustain pulses (at the end of the sustain period), a ramp waveform voltage that rises with second gradient G2, which is steeper than first gradient G1, from voltage 0 (V) toward voltage Vr is applied to scan electrode SC1-scan electrode SCn. This setting can make the time from voltage 0 (V) to voltage Vr shorter than that in the sustain period of subfield SF1 by (Vr/G1)-(Vr/G2) also in the sustain periods of subfield SF3-subfield SF5.

The above description has outlined the driving voltage waveforms applied to the respective electrodes of panel 10 in this exemplary embodiment.

In this exemplary embodiment, voltages are set as follows: voltage Vi1=150 (V); voltage Vi2=360 (V); voltage Vi3=210 (V); voltage Vi4=−180 (V); voltage Vc=−50 (V); voltage Va=−200 (V); voltage Vs=210 (V); voltage Vr=210 (V); voltage Ve=130 (V); and voltage Vd=60 (V).

In this exemplary embodiment, first gradient G1 is set to 1.5 (V/μsec) and second gradient G2 is set to 10.0 (V/μsec).

The gradient of the up-ramp waveform voltage to be applied to scan electrode SC1-scan electrode SCn in the initializing period of subfield SF1 is set to 1.5 (V/μsec), and the gradient of the down-ramp waveform voltage is set to −2.5 (V/μsec). The gradient of the down-ramp waveform voltage to be applied to scan electrode SC1-scan electrode SCn in the initializing periods of subfield SF2-subfield SF5 is set to −2.5 (V/μsec).

The specific numerical values, such as the above voltage values and the gradients, are only examples. In the present invention, the respective voltage values or gradients are not limited to the above numerical values. Preferably, the respective voltage values, gradients, or the like are set optimally for the discharge characteristic of the panel and the specifications of the plasma display apparatus, for example.

Next, a description is provided for a subfield structure of one field period in driving the plasma display apparatus of this exemplary embodiment.

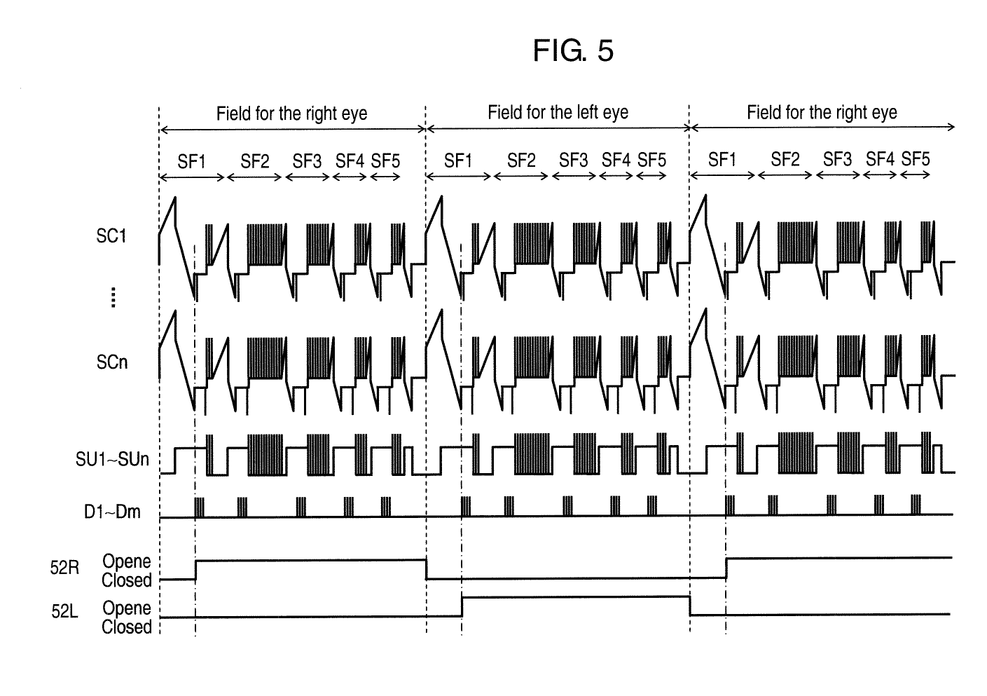

FIG. 5 is a diagram schematically showing a subfield structure in plasma display apparatus 40, and opening/closing operations of pair of shutter glasses 50 in accordance with the first exemplary embodiment of the present invention.

FIG. 5 shows driving voltage waveforms applied to scan electrode SC1 for undergoing an address operation first in the address periods, scan electrode SCn for undergoing an address operation last in the address periods, sustain electrode SU1-sustain electrode SUn, and data electrode D1-data electrode Dm. FIG. 5 also shows opening/closing operations of right eye liquid crystal shutter 52R and left eye liquid crystal shutter 52L. FIG. 5 shows three fields.

In this exemplary embodiment, in order to display a stereoscopic image on panel 10, a field for the right eye and a field for the left eye are alternately generated. For example, among three fields shown in FIG. 5, the first field and the third field are fields for the right eye, where an image signal for the right eye is displayed on panel 10. The second field is a field for the left eye, where an image signal for the left eye is displayed on panel 10.

The user who views a stereoscopic image displayed on panel 10 through pair of shutter glasses 50 perceives images displayed in two fields (an image for the right eye and an image for the left eye) as one stereoscopic image. Thus, the user perceives the number of images displayed on panel 10 per second as a half the number of fields displayed per second. For instance, when the field frequency (the number of fields generated per second) of stereoscopic images displayed on the panel is 60 Hz, the user perceives 30 stereoscopic images per second. Therefore, in order to display 60 stereoscopic images per second, the field frequency needs to be set to 120 Hz, which is twice of 60 Hz. Then, in this exemplary embodiment, the field frequency (the number of fields generated per second) is set to twice (e.g. 120 Hz) the general field frequency such that the user can view stereoscopic moving images smoothly.

Each of fields for the right eye and fields for the left eye has five subfields (subfield SF1, subfield SF2, subfield SF3, subfield SF4, and subfield SF5). Subfield SF1-subfield SF5 have respective luminance weights of 1, 16, 8, 4, and 2.

In this manner, a subfield having the lightest luminance weight is generated first in a field, a subfield having the heaviest luminance weight is generated second, and subfields thereafter are generated so as to have luminance weights sequentially decreasing. In the initializing period of the subfield generated first in the field, a forced initializing operation is performed. In the initializing periods of the other subfields, a selective initializing operation is performed.

Based on ON/OFF of the shutter control signal output from control signal output part 46 and received by pair of shutter glasses 50, the opening/closing operation of right eye liquid crystal shutter 52R and left eye liquid crystal shutter 52L of pair of shutter glasses 50 is controlled in the following manner.

In pair of shutter glasses 50, right eye liquid crystal shutter 52R opens in synchronization with the start of the address period of subfield SF1 of a field for the right eye, and closes in the period after generation of sustain pulses in the sustain period of subfield SF5 in the field and before the start of the field for the left eye. In pair of shutter glasses 50, left eye liquid crystal shutter 52L opens in synchronization with the start of the address period of subfield SF1 of a field for the left eye, and closes in the period after generation of sustain pulses in the sustain period of subfield SF5 in the field and before the start of the field for the right eye.

Therefore, in pair of shutter glasses 50, in the period during which right eye liquid crystal shutter 52R is opened, left eye liquid crystal shutter 52L is closed. In the period during which left eye liquid crystal shutter 52L is opened, right eye liquid crystal shutter 52R is closed. Further, in any of fields for the right eye and fields for the left eye, right eye liquid crystal shutter 52R and left eye liquid crystal shutter 52L are both in a closed state in the period during which a forced initializing operation is performed.

Right eye liquid crystal shutter 52R and left eye liquid crystal shutter 52L repeat the same operation in each field.

With this operation, in a plasma display system of this exemplary embodiment, the light emission generated by the forced initializing operation is blocked by right eye liquid crystal shutter 52R and left eye liquid crystal shutter 52L, and does not enter the eyes of the user. Therefore, the user who views a stereoscopic image through pair of shutter glasses 50 does not perceive the light emission caused by the forced initializing operation. Thus, the luminance of black level is reduced by the luminance caused by that light emission. In this manner, the user can view an image of high contrast with reduced luminance of black level.

Timing generation circuit 45 generates timing signals such that control signal output part 46 outputs shutter control signals for allowing right eye liquid crystal shutter 52R and left eye liquid crystal shutter 52L to perform the opening/closing operations of the above shutters. The timing generation circuit supplies the timing signals to control signal output part 46.

In this exemplary embodiment, the state where “shutter is closed” is not limited to the state where right eye liquid crystal shutter 52R and left eye liquid crystal shutter 52L are completely closed. The state where “shutter is opened” is not limited to the state where right eye liquid crystal shutter 52R and left eye liquid crystal shutter 52L are completely opened.

In this exemplary embodiment, structuring the respective subfields and controlling pair of shutter glasses 50 as described above can suppress the crosstalk between images for the right eye and images for the left eye and cause an address discharge stably, thereby displaying a high-quality stereoscopic image on panel 10. Hereinafter, the reason is described.

First, crosstalk is considered. Phosphor layers 35 for use in panel 10 have afterglow characteristics depending on the materials making up the phosphors. This afterglow is a phenomenon such that the phosphor maintains light emission even after the completion of discharge. The intensity of the afterglow is proportional to the luminance when the phosphor emits light. When the phosphor emits light at a higher luminance, the afterglow is more intense. The afterglow attenuates with a time constant corresponding to the characteristic of the phosphor. With a lapse of time, the luminance gradually decreases. For example, however, there is a phosphor material that has a characteristic of persistence of afterglow for several milliseconds after the completion of a sustain discharge. When the phosphor emits light at a higher luminance, the time taken for attenuation is longer.

The light emission in a subfield having a heavier luminance weight causes a luminance higher than that of the light emission in a subfield having a lighter luminance weight. Therefore, the afterglow caused by the light emission in a subfield having a heavier luminance weight has a higher luminance and takes a longer attenuation time than the afterglow caused by the light emission in a subfield having a lighter luminance weight.

For this reason, when the last subfield of one field is a subfield having a heavy luminance weight, the afterglow leaking into the succeeding field is larger than that when the last subfield is a subfield having a light luminance weight.

In plasma display apparatus 40 for displaying a stereoscopic image on panel 10 by alternately generating a field for the right eye and a field for the left eye, when the afterglow generated in one field leaks into the succeeding field, the afterglow is perceived by the user as unnecessary light emission unrelated to the image signal. This phenomenon is crosstalk.

Therefore, as the afterglow leaking from one field into the next field increases, the crosstalk increases. This inhibits the stereoscopic view of a stereoscopic image and degrades the image display quality in plasma display apparatus 40. This image display quality is the image display quality for the user who views a stereoscopic image through pair of shutter glasses 50.

In order to reduce the afterglow leaking from one field into the next field and reduce the crosstalk, it is preferable to generate a subfield having a large luminance weight at an earlier time of one field such that the strong afterglow is settled in that field.

Therefore, the following structure is preferable in suppressing the crosstalk only. A subfield having the heaviest luminance weight is generated first in a field, the luminance weight is decreased in the generation order of the subfields, and the last subfield of the field is a subfield having the lightest luminance weight. In this manner, the leak of the afterglow into the next field is minimized.

Next, stability of the address discharge is considered. In a discharge cell displaying a bright gradation, a sustain discharge occurs in a plurality of subfields in one field. Therefore, in the discharge cell, a sufficient amount of priming particles caused by these sustain discharges is generated, which can cause a stable address discharge. However, in a discharge cell displaying a dark gradation, especially in a discharge cell to be lit only in the subfield having the lightest luminance weight, insufficient priming particles are likely to destabilize the address discharge.

In this exemplary embodiment, in order to reduce luminance of black level, a forced initializing operation is performed in subfield SF1, and a selective initializing operation is performed in the other subfields. Therefore, in the initializing period of subfield SF1, an initializing discharge can be caused in all the discharge cells so as to generate wall charge and priming particles necessary for the address operation. However, this wall charge and priming particles are gradually lost with a lapse of time.

For example, the wall charge and priming particles in the last subfield (e.g. subfield SF5) of one field are compared between a discharge cell undergoing an address operation in intermediate subfields (e.g. any one or a plurality of subfield SF1-subfield SF4) and a discharge cell undergoing no address operation in the intermediate subfields. In this case, the wall charge and priming particles are less in the discharge cell undergoing no address operation in the intermediate subfields.

In the discharge cell undergoing an address operation in the intermediate subfields, a sustain discharge is caused by the address operation, which generates wall charge and priming particles. In contrast, in the discharge cell undergoing no address operation in the intermediate subfields, no sustain discharge occurs after the initializing operation in subfield SF1 immediately before the last subfield. Thus, there is no opportunity to generate wall charge and priming particles. As a result, the wall charge and priming particles in the discharge cell reduce more. This can destabilize the address operation in the last subfield.

In the subfield having the heaviest luminance weight, a sustain discharge occurs in a discharge cell displaying bright gradations but no sustain discharge occurs in a discharge cell displaying dark gradations. For example, when an image in a dark pattern is displayed on panel 10, no sustain discharge occurs in a subfield having the heaviest luminance weight in some cases. It is experimentally verified that the number of lit discharge cells is larger in a subfield having a lighter luminance weight in a generally viewed moving image. For this reason, when a typical moving image is displayed on panel 10, the probability of occurrence of a sustain discharge in the subfield having the lightest luminance weight is higher than the probability of occurrence of a sustain discharge in the subfield having the heaviest luminance weight, which depends on the pattern of the image. That is, the probability of occurrence of a sustain discharge in the subfield having the heaviest luminance weight is lower than the probability of occurrence of a sustain discharge in the subfield having the lightest luminance weight.

Therefore, in a structure where the luminance weight of subfield SF1 is the heaviest and the luminance weight is sequentially decreased toward the last subfield, the probability of occurrence of a sustain discharge in subfield SF1 is low. Thus, the address operation in the last subfield can be unstable in some discharge cells.

Then, in this exemplary embodiment, the structure is set such that subfield SF1 is a subfield having the lightest luminance weight, subfield SF2 is a subfield having the heaviest luminance weight, and subfield SF3 and thereafter have luminance weights sequentially decreasing.

This structure can make the number of discharge cells undergoing a sustain discharge in subfield SF1 greater than that in a structure where the luminance weight is sequentially decreased from subfield SF1 toward the last subfield.

When a sustain discharge occurs in subfield SF1, the sustain discharge can replenish the wall charge and priming particles in the discharge cells. Thus, the address operation in the last subfield can be performed more stably.

Subfield SF1 is a subfield where a forced initializing operation is performed. Thus, in subfield SF1, while the priming particles generated in the forced initializing operation is remaining, an address discharge can be caused, which allows a stable address operation. Therefore, even in discharge cells to be lit only in the subfield having the lightest luminance weight, a stable address discharge can be caused.

Further, since a subfield having a heavy luminance weight can be generated at an earlier time of one field, the magnitude of the afterglow can be sequentially reduced in subfield SF2 and thereafter, and the leak of the afterglow into the next field, i.e. crosstalk, can be reduced.

That is, in plasma display apparatus 40 of this exemplary embodiment, the address operation in the last subfield can be stabilized in addition to the above reduction of crosstalk.

Further, in this exemplary embodiment, first gradient G1 is set gentler than second gradient G2. That is, the up-ramp waveform voltage to be applied to scan electrode SC1-scan electrode SCn at the end of the sustain period of subfield SF1 generated first in a field is generated with a gradient gentler than that of the up-ramp waveform voltage to be applied to scan electrode SC1-scan electrode SCn at the end of the sustain periods of subfield SF2-subfield SF5. This operation can cause the address discharge more stably. Hereinafter, the reason is described.

The up-ramp waveform voltage applied to scan electrode SC1-scan electrode SCn at the end of the sustain periods can cause a weak discharge in the discharge cells having undergone a sustain discharge, thereby precisely adjusting the wall voltage in the discharge cells. In order to cause this weak discharge stably and precisely, it is necessary to be careful of the amount of priming particles supplied and the gradients of the ramp waveform voltages.

For instance, if a ramp waveform voltage with a steep gradient is applied to scan electrode SC1-scan electrode SCn while an insufficient amount of priming particles are supplied to the discharge cells at the end of the sustain period, the intensity of the weak discharge periodically fluctuates, which reduces the precision in adjusting the wall voltage. Further, insufficient priming particles or the steep gradient of the ramp waveform voltage can cause a strong discharge in the discharge cells, thus making it difficult to perform a normal address operation in the succeeding address period.

In this exemplary embodiment, as described above, a subfield having the lightest luminance weight is generated first in a field, a subfield having the heaviest luminance weight is generated second, and subfields thereafter are generated so as to have luminance weights sequentially decreasing.

Since subfield SF2 is the subfield having the heaviest luminance weight, this subfield has the largest effect on the display image. Therefore, if a normal address operation is not performed in this subfield SF2, the image display quality in plasma display apparatus 40 considerably decreases.

In order to cause an address discharge stably in subfield SF2 so as to display a high-quality image on panel 10, it is extremely important to cause a stable discharge in subfield SF1, which is immediately before subfield SF2.

Since subfield SF1 is a subfield having the lightest luminance weight, the amount of priming particles generated by a sustain discharge is smaller than that in the other subfields. Therefore, in order to cause a weak discharge stably and precisely at the end of the sustain period, it is preferable to set the up-ramp waveform voltage applied to scan electrode SC1-scan electrode SCn at the end of the sustain period so as to have a gentle gradient.

In contrast, since subfield SF2-subfield SF4 are subfields having relatively heavy luminance weights, the amount of priming particles caused by a sustain discharge is large. Therefore, the gradient of the ramp waveform voltage applied to scan electrode SC1-scan electrode SCn at the end of the sustain periods can be set steep. This can shorten the time taken for driving.

Since subfield SF5 is a subfield having the second lightest luminance weight, the amount of priming particles caused by a sustain discharge is relatively small. Thus, the weak discharge at the end of the sustain period can be unstable. However, in the initializing period of subfield SF1, i.e. the first subfield of the succeeding field, a forced initializing operation is performed. Therefore, even if the weak discharge at the end of the sustain period in subfield SF5, i.e. the last subfield of the field, is unstable, this unstable discharge substantially does not affect the address operation or sustain operation in the succeeding field.

In this manner, in this exemplary embodiment, each of fields for the right eye and fields for the left eye has a plurality of subfields each having the following periods: an initializing period during which a down-ramp waveform voltage is applied to scan electrode SC1-scan electrode SCn; an address period during which a scan pulse is applied to scan electrode SC1-scan electrode SCn and an address pulse is applied selectively to data electrode D1-data electrode Dm; and a sustain period during which sustain pulses corresponding in number to the luminance weight are applied to scan electrode SC1-scan electrode SCn and sustain electrode SU1-sustain electrode SUn, and thereafter an up-ramp waveform voltage is applied to scan electrode SC1-scan electrode SCn.

The luminance weights of the respective subfields are set such that subfield SF1 generated first in a field is the subfield having the lightest luminance weight, next subfield SF2 is the subfield having the heaviest luminance weight, and subfields thereafter have luminance weights sequentially decreasing.

Further, in the sustain period of each subfield, an up-ramp waveform voltage is applied to scan electrode SC1-scan electrode SCn after all the sustain pulses have been generated. First gradient G1, i.e. the gradient of the up-ramp waveform voltage applied to scan electrode SC1-scan electrode SCn in the sustain period of subfield SF1, is set to a gradient gentler than second gradient G2, i.e. the gradient of the up-ramp waveform voltage applied to scan electrode SC1-scan electrode SCn in the sustain periods of subfield SF2-subfield SF5.

With plasma display apparatus 40 and the plasma display system in this exemplary embodiment, the above setting can cause an address discharge stably while suppressing the crosstalk between an image for the right eye and an image for the left eye in display of a stereoscopic image on panel 10. Thereby, the user can view a high-quality stereoscopic image when viewing a stereoscopic image displayed on panel 10 through pair of shutter glasses 50.

FIG. 5 shows an example where a down-ramp waveform voltage is generated and applied to scan electrode SC1-scan electrode SCn and voltage Ve is applied to sustain electrode SU1-sustain electrode SUn in the period after the completion of subfield SF5 and before the start of subfield SF1. However, these voltages do not need to be generated necessarily. For example, in the period after the completion of subfield SF5 and before the start of subfield SF1, scan electrode SC1-scan electrode SCn, sustain electrode SU1-sustain electrode SUn, and data electrode D1-data electrode Dm may be kept at 0 (V).

Next, a description is provided for an example of a scan electrode driver circuit in this exemplary embodiment.

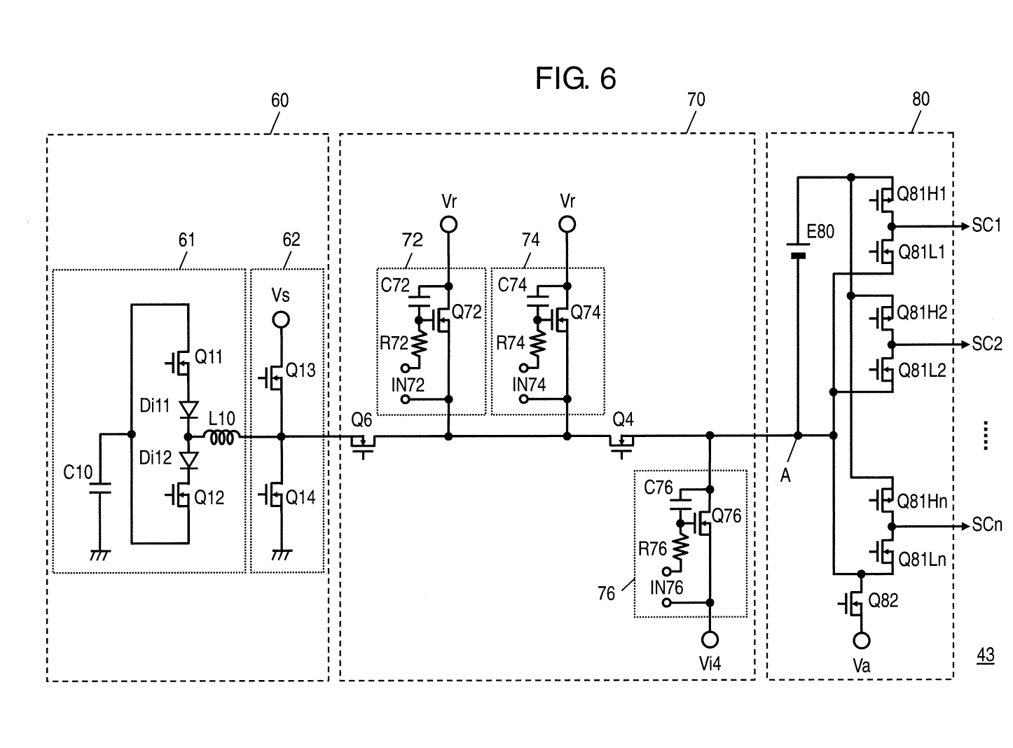

FIG. 6 is a circuit diagram showing a configuration example of scan electrode driver circuit 43 of plasma display apparatus 40 in accordance with the first exemplary embodiment of the present invention. Scan electrode driver circuit 43 includes sustain pulse generation circuit 60, ramp waveform generation circuit 70, and scan pulse generation circuit 80. The respective output terminals of scan pulse generation circuit 80 are connected to scan electrode SC1-scan electrode SCn of panel 10. This is intended to apply a scan pulse separately to each of scan electrodes 22 in the address periods.

In this exemplary embodiment, the voltage input to scan pulse generation circuit 80 is denoted as “reference electric potential A”. In the following description, the operation of bringing a switching element into conduction is denoted as “ON”, and the operation of bringing a switching element out of conduction is denoted as “OFF”. Each circuit block of scan electrode driver circuit 43 is controlled by the timing signals supplied from timing generation circuit 45. The detailed paths for the timing signals are omitted.

FIG. 6 shows a separation circuit including switching element Q4, for electrically separating sustain pulse generation circuit 60 and circuits based on voltage Vr (e.g. Miller integration circuit 72 and Miller integration circuit 74) from a circuit based on negative voltage (e.g. Miller integration circuit 76) while the latter circuit is operated. FIG. 6 also shows a separation circuit including switching element Q6, for electrically separating circuits based on voltage Vr (e.g. Miller integration circuit 72 and Miller integration circuit 74) from sustain pulse generation circuit 60 based on voltage Vs while the former circuits are operated.

Sustain pulse generation circuit 60 has power recovery circuit 61 for recovering the electric power for driving scan electrode SC1-scan electrode SCn from panel 10 and reusing the electric power, and clamp circuit 62 for clamping scan electrode SC1-scan electrode SCn to voltage Vs or voltage 0 (V).

Power recovery circuit 61 has power recovery capacitor C10, switching element Q11, switching element Q12, blocking diode Dil1, blocking diode Di12, and resonance inductor L10. The power recovery circuit causes LC resonance between interelectrode capacitance Cp and inductor L10 so as to cause a sustain pulse to rise and fall.

Clamp circuit 62 has switching element Q13 for clamping scan electrode SC1-scan electrode SCn to voltage Vs, and switching element Q14 for clamping scan electrode SC1-scan electrode SCn to voltage 0 (V) as the base electric potential. The clamp circuit connects reference electric potential A to power supply VS via switching element Q13 so as to clamp scan electrode SC1-scan electrode SCn to voltage Vs, and grounds reference electric potential A via switching element Q14 so as to clamp scan electrode SC1-scan electrode SCn to voltage 0 (V).

Sustain pulse generation circuit 60 operates power recovery circuit 61 and clamp circuit 62 by switching conduction (ON) and shutoff (OFF) of switching element Q11, switching element Q12, switching element Q13, and switching element Q14, based on the timing signals supplied from timing generation circuit 45. Thus, the scan pulse generation circuit generates sustain pulses.

Ramp waveform generation circuit 70 has Miller integration circuit 72, Miller integration circuit 74, and Miller integration circuit 76, and generates ramp waveform voltages shown in FIG. 4.

Miller integration circuit 72 has transistor Q72, capacitor C72, and resistor R72. By applying a constant voltage to input terminal IN72 (applying a constant voltage difference between two circles illustrated as input terminal IN72), the Miller integration circuit generates an up-ramp waveform voltage that rises toward voltage Vr with first gradient G1. This up-ramp waveform voltage is an up-ramp waveform voltage applied to scan electrode SC1-scan electrode SCn at the end of the sustain period of subfield SF1.

Miller integration circuit 74 has transistor Q74, capacitor C74, and resistor R74. By applying a constant voltage to input terminal IN74 (applying a constant voltage difference between two circles illustrated as input terminal IN74), the Miller integration circuit generates an up-ramp waveform voltage that rises toward voltage Vr with second gradient G2. This up-ramp waveform voltage is an up-ramp waveform voltage applied to scan electrode SC1-scan electrode SCn at the end of the sustain periods of subfield SF2-subfield SF5.

Miller integration circuit 76 has transistor Q76, capacitor C76, and resistor R76. By applying a constant voltage to input terminal IN76 (applying a constant voltage difference between two circles illustrated as input terminal IN76), the Miller integration circuit generates a ramp waveform voltage that gently falls toward voltage V14. This down-ramp waveform voltage is a down-ramp waveform voltage applied to scan electrode SC1-scan electrode SCn in the initializing periods of subfield SF1-subfield SF5.

In this exemplary embodiment, the up-ramp waveform voltage applied to scan electrode SC1-scan electrode SCn in the initializing period of subfield SF1 is generated by Miller integration circuit 72. However, a Miller integration circuit dedicated to generate the up-ramp waveform voltage to be applied to scan electrode SC1-scan electrode SCn in the initializing period of subfield SF1 may be provided.

Scan pulse generation circuit 80 has switching element Q81H1-switching element Q81Hn, switching element Q81L1-switching element Q81Ln, switching element Q82, a power supply for negative voltage Va, and power supply E80 for generating voltage VC.

Power supply E80 generates voltage VC and generates voltage Vc (where Vc=VC+Va) by superimposing voltage VC on reference electric potential A of scan pulse generation circuit 80. Switching element Q81H1-switching element Q81Hn are switching elements for outputting a voltage on the high voltage side of power supply E80. Switching element Q81L1-switching element Q81Ln are switching elements for outputting a voltage on the low voltage side of power supply E80, i.e. reference electric potential A.

Then, the scan pulse generation circuit 80 applies scan pulses to scan electrode SC1-scan electrode SCn by switching voltage Va and voltage Vc. Thereby, the scan pulse generation circuit 80 applies the scan pulses to each of scan electrode SC1-scan electrode SCn at the timing shown in FIG. 4.

Scan pulse generation circuit 80 applies the output from sustain pulse generation circuit 60 or the output from ramp waveform generation circuit 70 to each of scan electrode SC1-scan electrode SCn in the initializing periods and the sustain periods.

In this exemplary embodiment, as described above, Miller integration circuit 72 and Miller integration circuit 74 for generating up-ramp waveform voltages having different gradients are provided in scan electrode driver circuit 43. Thereby, up-ramp waveform voltages having gradients different between subfield SF1 and subfield SF2-subfield SF5 can be applied to scan electrode SC1-scan electrode SCn at the end of the sustain periods.

Sustain pulse generation circuit 60, ramp waveform generation circuit 70, and scan pulse generation circuit 80 shown in FIG. 6 are only examples. In the present invention, each circuit forming the scan electrode driver circuit is not limited to the circuit shown in FIG. 6. For example, the following configuration may be used. A Miller integration circuit for generating up-ramp waveform voltages is provided in the scan electrode driver circuit, and one of the input voltage of the Miller integration circuit, the resistance of the resistor forming the Miller integration circuit, and the capacitance of the capacitor forming the Miller integration circuit is switched so as to generate the up-ramp waveform voltages having different gradients.

### Second Exemplary Embodiment

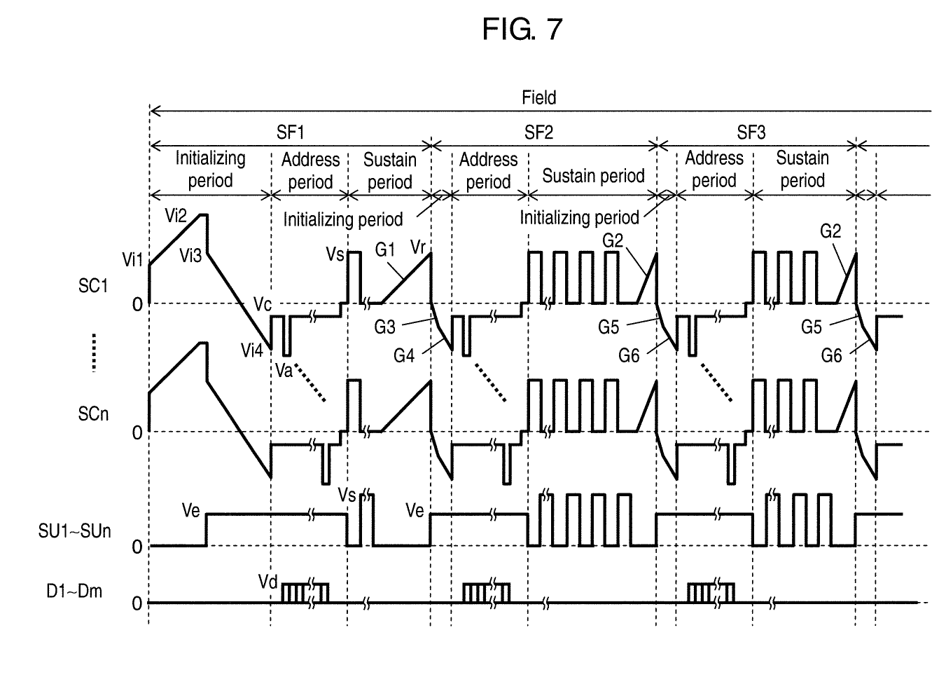

FIG. 7 is a chart schematically showing driving voltage waveforms applied to the respective electrodes of panel 10 for use in the plasma display apparatus in accordance with the second exemplary embodiment of the present invention. FIG. 7 shows driving voltage waveforms applied to the following electrodes: scan electrode SC1 for undergoing an address operation first in the address periods; scan electrode SCn for undergoing an address operation last in the address periods; sustain electrode SU1-sustain electrode SUn; and data electrode D1-data electrode Dm.

FIG. 7 also shows driving voltage waveforms in subfield SF1-subfield SF3. In the second exemplary embodiment, similarly to the first exemplary embodiment, subfield SF1 is a subfield where a forced initializing operation is performed, and subfield SF2 and subfield SF3 are subfields where a selective initializing operation is performed. Therefore, between subfield SF1, and subfield SF2 and subfield SF3, the waveform shapes of the driving voltage applied to scan electrodes 22 in the initializing periods are different.

In the second exemplary embodiment, similarly to the first exemplary embodiment, an up-ramp waveform voltage that rises with first gradient G1 from voltage 0 (V) toward voltage Vr is applied to scan electrode SC1-scan electrode SCn at the end of the sustain period of subfield SF1. At the end of the sustain periods of subfield SF2-subfield SF5, an up-ramp waveform voltage that rises with second gradient G2, which is steeper than first gradient G1, from voltage 0 (V) toward voltage Vr is applied to scan electrode SC1-scan electrode SCn.

However, in the second exemplary embodiment, a down-ramp waveform voltage applied to scan electrode SC1-scan electrode SCn in the initializing periods of subfield SF2-subfield SF5 does not fall with a constant gradient as shown in the first exemplary embodiment. The down-ramp waveform voltage is generated with a changing gradient. For example, the down-ramp waveform voltage falls relatively steeply first, and relatively gently next.

Specifically, in the initializing period of subfield SF2, a ramp waveform voltage that falls with relatively steep gradient G3 first and relatively gentle gradient G4 next is generated and applied to scan electrode SC1-scan electrode SCn.

In the initializing periods of subfield SF3-subfield SF5, a ramp waveform voltage that falls with relatively steep gradient G5 first and relatively gentle gradient G6 next is generated and applied to scan electrode SC1-scan electrode SCn.

In the initializing periods, a gently falling voltage applied to scan electrode SC1-scan electrode SCn after generation of the initializing discharge can cause a weak initializing discharge in the discharge cells. Therefore, until immediately before the generation of the initializing discharge, the voltage applied to scan electrode SC1-scan electrode SCn may fall steeply. This structure can make the time taken for the initializing period shorter than the structure shown in the first exemplary embodiment, thus shortening the time taken for driving panel 10.

In this exemplary embodiment, gradient G3 and gradient G5 are −8.0 (V/μsec), and gradient G4 and gradient G6 are −2.5 (V/μsec).

However, in the present invention, the gradients of the down-ramp waveform voltages generated in the initializing periods are not limited to the above numerical values. For example, the luminance weights in subfield SF2-subfield SF4 are relatively large and the amount of priming particles generated by the sustain discharge is relatively large. Thus, the gradients of the down-ramp waveform voltages generated in the initializing periods of subfield SF3-subfield SF5 can be set steep to a certain extent. Therefore, gradient G5 may be set steeper than −8.0 (V/μsec), and gradient G6 may be set steeper than −2.5 (V/μsec). In accordance with the discharge characteristic of panel 10, gradient G3 may be set gentler than gradient G5, and gradient G4 may be set gentler than gradient G6.

In the examples described in the first exemplary embodiment and the second exemplary embodiment, one field is formed of five subfields. However, in the present invention, the number of subfields forming one field is not limited to the above number. For example, setting the number of subfields greater than five can increase the number of gradations displayable on panel 10.

In the examples described in the first exemplary embodiment and the second exemplary embodiment, the luminance weights of the subfields are powers of “2”, that is, the respective luminance weights of subfield SF1-subfield SF5 are set to 1, 16, 8, 4, and 2. However, the luminance weights set to the respective subfields are not limited to the above numerical values. Setting the luminance weights to 1, 12, 7, 3, and 2, for example, gives redundancy to the combination of the subfields determining gradations and allows the coding capable of suppressing the occurrence of a moving image false contour. The number of subfields forming one field, the luminance weights of the respective subfields, or the like is set appropriately for the characteristics of panel 10 and the specifications of plasma display apparatus 40, for example.

Each circuit block shown in the exemplary embodiments of the present invention may be formed as an electric circuit that performs each operation shown in the exemplary embodiments, or formed of a microcomputer, for example, programmed so as to perform the similar operations.

In the examples described in the exemplary embodiments, one pixel is formed of discharge cells of R, G, and B three colors. Also a panel that includes pixels, each formed of discharge cells of four or more colors, can use the configuration shown in the exemplary embodiments and provide the same advantages.

The above driver circuit is only an example and the configuration of the driver circuit is not limited to the above configuration.

The specific numerical values shown in the exemplary embodiments of the present invention are set based on the characteristics of panel 10 that has a 50-inch screen and 1024 display electrode pairs 24, and simply show examples in the exemplary embodiments. The present invention is not limited to these numerical values. Preferably, each numerical value is set optimally for the characteristics of the panel, the specifications of the plasma display apparatus, or the like. Variations are allowed for each numerical value within the range in which the above advantages can be obtained. The number of subfields, the luminance weights of the respective subfields, or the like is not limited to the values shown in the exemplary embodiments of the present invention. The subfield structure may be switched based on image signals, for example.

### INDUSTRIAL APPLICABILITY

The present invention can enhance the image display quality by reducing crosstalk to the user who views a stereoscopic image displayed on the panel through a pair of shutter glasses and causing an address discharge stably, in a plasma display apparatus usable as a stereoscopic image display apparatus. Thus, the present invention is useful as a plasma display apparatus driving method, a plasma display apparatus, and a plasma display system.

### REFERENCE MARKS IN THE DRAWINGS

10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35 Phosphor layer
40 Plasma display apparatus
41 Image signal processing circuit
42 Data electrode driver circuit
43 Scan electrode driver circuit
44 Sustain electrode driver circuit
45 Timing generation circuit
46 Control signal output part
50 Pair of shutter glasses
51 Control signal receiver
52R Right eye liquid crystal shutter
52L Left eye liquid crystal shutter
60 Sustain pulse generation circuit
61 Power recovery circuit
62 Clamp circuit
70 Ramp waveform generation circuit
72, 74, 76 Miller integration circuit
80 Scan pulse generation circuit
Q4, Q6, Q11, Q12, Q13, Q14, Q72, Q74, Q76, Q81H1-Q81Hn, Q81L1-Q81Ln,
Q82 Switching element
Dil1, Di12 Diode
L10 Inductor
C10, C72, C74, C76 Capacitor
R72, R74, R76 Resistor
E80 Power supply

1. A plasma display apparatus driving method,
the plasma display apparatus displaying an image by alternately repeating a field for a right eye for display of an image signal for the right eye and a field for a left eye for display of an image signal for the left eye, using a plasma display panel,
the plasma display panel having a plurality of discharge cells arranged therein, each of the discharge cells having a scan electrode, a sustain electrode, and a data electrode,
the driving method comprising:
setting each of the field for the right eye and the field for the left eye such that each of the fields has a plurality of subfields, each of the subfields has an initializing period, an address period, and a sustain period where an up-ramp waveform voltage is applied to the scan electrodes after sustain pulses corresponding in number to a luminance weight are applied;
in each of the field for the right eye and the field for the left eye, setting the luminance weights of the respective subfields such that a first subfield is a subfield having a lightest luminance weight, a second subfield generated is a subfield having a heaviest luminance weight, and a third subfield and thereafter have luminance weights sequentially decreasing; and
generating the up-ramp waveform voltage to be applied to the scan electrodes in the sustain period of the first subfield in each of the field for the right eye and the field for the left eye such that the up-ramp waveform voltage has a gradient gentler than that of the up-ramp waveform voltage to be applied to the scan electrodes in the sustain periods of the second subfield and thereafter.

2. A plasma display apparatus comprising:
a plasma display panel having a plurality of discharge cells arranged therein, each of the discharge cells having a scan electrode, a sustain electrode, and a data electrode; and
a driver circuit for driving the plasma display panel,
the plasma display apparatus displaying an image on the plasma display panel by alternately repeating a field for a right eye for display of an image signal for the right eye and a field for a left eye for display of an image signal for the left eye,
wherein the driver circuit drives the plasma display panel in a manner such that:
each of the field for the right eye and the field for the left eye has a plurality of subfields, each of the subfields has an initializing period, an address period, and a sustain period where an up-ramp waveform voltage is applied to the scan electrodes after sustain pulses corresponding in number to a luminance weight are applied;
in each of the field for the right eye and the field for the left eye, the luminance weights of the respective subfields are set such that a first subfield is a subfield having a lightest luminance weight, a second subfield is a subfield having a heaviest luminance weight, and third subfields and thereafter have luminance weights sequentially decreasing; and
the up-ramp waveform voltage to be applied to the scan electrodes in the sustain period of the first subfield in each of the field for the right eye and the field for the left eye is generated so as to have a gradient gentler than that of the up-ramp waveform voltage to be applied to the scan electrodes in the sustain periods of the second subfield and thereafter.

3. The plasma display apparatus of claim 2, wherein the driver circuit includes a control signal output part for outputting a shutter control signal in synchronization with the field for the right eye and the field for the left eye.

4. A plasma display system comprising:
a plasma display apparatus including:
a plasma display panel having a plurality of discharge cells arranged therein, each of the discharge cells having a scan electrode, a sustain electrode, and a data electrode; and
a driver circuit for driving the plasma display panel, the driver circuit including a control signal output part for outputting a shutter control signal in synchronization with a field for a right eye and a field for a left eye,
the plasma display apparatus displaying an image on the plasma display panel by alternately repeating the field for the right eye for display of an image signal for the right eye and the field for the left eye for display of an image signal for the left eye; and
a pair of shutter glasses including a control signal receiver for receiving the shutter control signal, a right eye shutter, and a left eye shutter, the right eye shutter and the left eye shutter opening and closing in response to the shutter control signal,
wherein the driver circuit drives the plasma display panel in a manner such that:
each of the field for the right eye and the field for the left eye has a plurality of subfields, each of the subfields has an initializing period, an address period, and a sustain period where an up-ramp waveform voltage is applied to the scan electrodes after sustain pulses corresponding in number to a luminance weight are generated;
in each of the field for the right eye and the field for the left eye, the luminance weights of the respective subfields are set such that a first subfield is a subfield having a lightest luminance weight, a second subfield is a subfield having a heaviest luminance weight, and third subfield and thereafter have luminance weights sequentially decreasing; and
the up-ramp waveform voltage to be applied to the scan electrodes in the sustain period of the first subfield in each of the field for the right eye and the field for the left eye is generated so as to have a gradient gentler than that of the up-ramp waveform voltage to be applied to the scan electrodes in the sustain periods of the second subfield and thereafter.
